(19) United States
(12) Patent Application Publication
(10) Pub. No.: US 2011/0223290 A1
(43) Pub. Date: Sep. 15, 2011

(54) Ice Cream Cone Stabilizer and Method

(76) Inventor: Erik Dorf, Breckenridge, CO (US)

(21) Appl. No.: 12/721,168

(22) Filed: Mar. 10, 2010

(51) Int. Cl. A23G 9/22; A23G 9/26; A23G 3/56

(52) U.S. Cl. 426/104; 426/283; 426/134; 428/80

(57) ABSTRACT

A stabilizer for ice cream cones is a generally flat elongated body with a tapered tip at one end and a rounded or novelty decoration at the other end. The center of the stabilizer may be flared to increase the surface area of the stabilizer. In use, the stabilizer is inserted into the ice cream within the cone so that the tapered end approaches the base of the inside of the cone, while the other end extends above the top of the ice cream. The stabilizer acts to prevent sideways movement of the ice cream that is above the top edge of the cone, and thus reduces the risk of the ice cream falling off the cone.

### BACKGROUND OF THE INVENTION

This application relates to a stabilizer for reducing the risk of ice cream falling from an ice cream cone, and to a related method.

Ice cream cones have been around for more than a century, and throughout that time people have experienced the misery of having the ice cream fall off of the cone as they eat it. Children become disappointed and parents or vendors may have to absorb the cost of a replacement. In addition, a melting blob of ice cream, whether on a sidewalk or the living room floor, is a mess requiring clean up. The “answer” to this problem has been to forego the cone, and serve ice cream in a cup with a spoon. While this may reduce spillage, it also detracts from the fun of eating an ice cream cone and is frequently not found to be an acceptable alternative, especially to young ice cream eaters.

### SUMMARY OF THE INVENTION

The present application provides a stabilizer for ice cream cones and a related method. The stabilizer is a generally flat elongated body that is tapered at one end and that has a rounded or novelty decoration at the other end. The center of the stabilizer may be flared to increase the surface area of the stabilizer. In use, the stabilizer is inserted into the ice cream within the cone so that the tapered end approaches the base of the inside of the cone, while the other end extends above the top of the ice cream. The stabilizer acts to prevent sideways movement of the ice cream that is above the top edge of the cone, and thus reduces the risk of the ice cream falling off the cone.

### BRIEF DESCRIPTION OF THE DRAWINGS

FIGS. 1A and B show a stabilizer in accordance with the invention.

FIG. 2A-E show cross sections through stabilizers in accordance with the invention.

FIG. 3 shows an ice cream cone with a stabilizer in accordance with the invention.

FIG. 4 shows a cut away view of a stabilizer inside an ice cream cone.

### DETAILED DESCRIPTION OF THE INVENTION

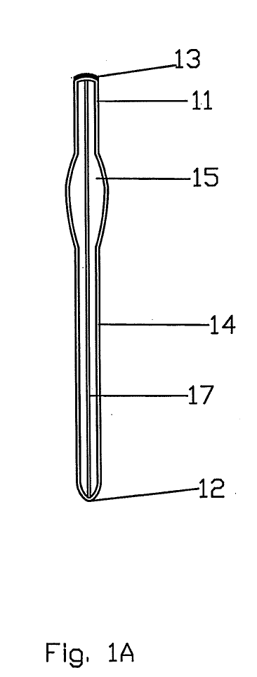

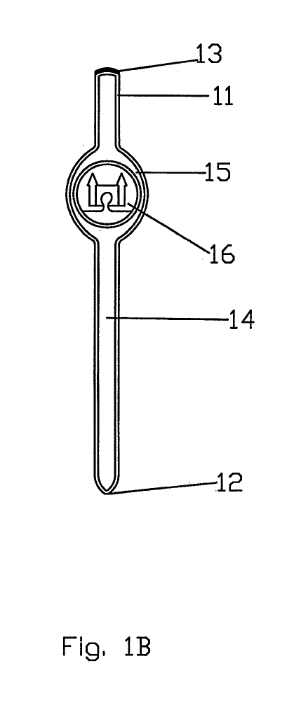

FIG. 1A shows an embodiment of the stabilizer of the invention. The stabilizer is generally flat in the plane of the drawing with a thickness sufficient to provide necessary levels of strength and rigidity in the material used so that the stabilizer can be pushed into ice cream within a cone. The strength and rigidity may be enhanced through the inclusion of edge ridges 11 or an optional central ridge 17. The central ridge 17, when present, may extend the full length of the stabilizer as shown in FIG. 1A, or only a partial length of the stabilizer, and may be on one or both surfaces.

The stabilizer has a tapered end 12 for insertion into the ice cream. The shape of the taper facilitates insertion into the ice cream, although the tip should not be sharp which would cause safety concerns especially for use by children. At the opposite end of the stabilizer is an outer end 13 which extends above the ice cream. In a simple embodiment such as that shown in FIG. 1A, this is simply a rounded end. As discussed below, however, the outer end may have a novelty or decorative shape or feature.

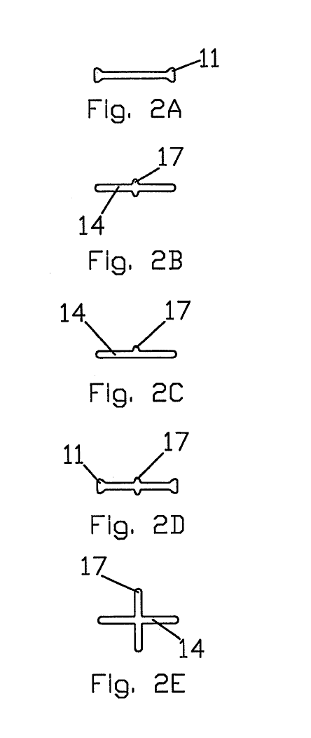

Between the tapered end 12 and the outer end 13 is the elongated body 14 of the stabilizer. As used in the specification and claims of this application, the term elongated means that the length of the stabilizer exceeds the width of the stabilizer by a factor of 5 or more, preferably 8 or more. The width in this case is the average, substantially constant width away from any tapers, flares or decorative features. The length of the body 14 is selected to conform with the anticipated length of an ice cream cone and the ice cream extending above the top edge of the cone, allowing for an extension of the outer end above the ice cream as shown in FIG. 2. To accommodate different sizes and types of cones, and different amounts of ice cream, the length of the stabilizer will commonly be in the range of 3 to 9 inches.

Between the two ends of the stabilizer is an optional flared area 15. When present, the flared area 15 provides lateral resistance to movement of the stabilizer in ice cream, and is closer to the outer end 13 than the tapered end 12. The flared area 15 can be a simple shape, as shown in FIG. 1A, or is can be a novelty shape, such as a cartoon character or a medallion with a logo of an amusement park such that the stabilizer becomes a souvenir of a vacation experience when the ice cream is finished. FIG. 1B shows an alternative variation of the stabilizer in which the flared area 15 is formed as an open circle, into which a novelty medallion 16 is fitted. This allows the same base stabilizer to be used for different medallions.

FIGS. 2A-E show cross sections through the elongated body 14 of several embodiments of the stabilizer of the invention. FIG. 2A shows a cross section of an embodiment with an edge ridge 11 but no central ridge. FIG. 2B shows an embodiment with a central ridge 17 on both surfaces of the elongated body 14 but no edge ridges. FIG. 2C shows an embodiment with a central ridge 17 on one surfaces of the elongated body 14 but no edge ridges. FIG. 2D shows an embodiment with both an edge ridge 11 and a central ridge 17. FIG. 2E shows an embodiment in which the size of the central ridge 17 is comparable to the elongated body portion 14.

The stabilizer can be made out of any material suitable from a cost and strength perspective to the intended use. In embodiments, the stabilizer is made from light weight wood, although the preferred material will be a molded plastic. In some embodiment, the stabilizer is made in whole or in part from a candy such that it serves to add flavor to the ice cream cone or as a separate consumable treat.

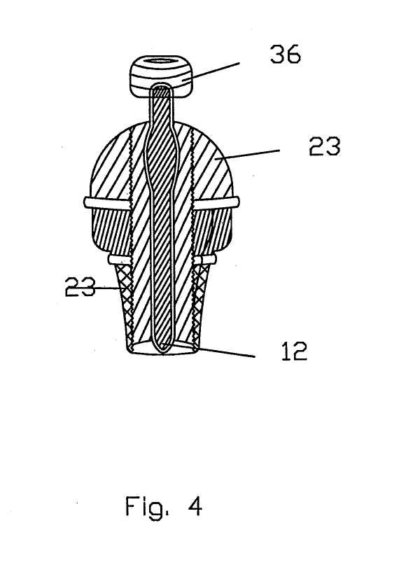

In FIG. 4, the top of the stabilizer has a novelty outer end in the form of a candy ball 36 formed over the outer end. In other embodiments, the novelty or decorative outer end can be a cartoon character or logo to create a souvenir.

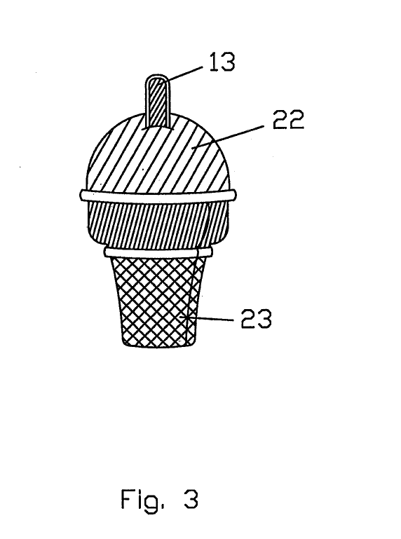

FIG. 3 shows a side view of an ice cream cone with the stabilizer in place, with outer end 13 extending upwards from the ice cream 22. The positioning of the stabilizer within the ice cream 22 and the cone 23 is shown in cut away view of FIG. 4. As shown, in use the stabilizer is inserted into the ice cream 22 within the cone 23 so that the tapered end 12 approaches the base of the cone, while the other end extends above the top of the ice cream.

It will be appreciated that the closeness with which the stabilizer “approaches” the base of the cone is not critical, provided that there is sufficient length of stabilizer within the ice cream cone to reduce spillage of ice cream and provided that the stabilizer does not poke through the bottom of the cone.

The ice cream cone depicted in FIGS. 2 and 3 is the flat-bottomed variety commonly referred to as a “kiddie cone.” The invention is applicable to conical-bottom cones and waffle cones as well. Similarly, the invention may be used with soft serve ice cream and scooped ice cream.

While the various features of the stabilizer as described above represent preferred embodiments of the stabilizer itself, the invention also provides a method for reducing risk of spillage from an ice cream cone comprising the steps of:
(a) putting ice cream into an ice cream cone; and
(b) inserting a stabilizer through the ice cream, said stabilizer having an generally flat elongated body and a tapered tip at one end, said tapered tip being inserted through the ice cream until it approaches the inside bottom of the cone, and wherein the stabilizer has an end opposite the tapered end that extends upwards above the ice cream. The stabilizer restricts the ability of the ice cream to move sideways relative to the ice cream cone, and thus reduces the risk of spillage. Thus in the method of the invention, the incorporation of additional features of the stabilizer is optional.

The steps of the method can be performed in either order. Thus, in one embodiment, the ice cream is first placed in the cone, and the stabilizer is then inserted into the cone. The ice cream may also be dispensed into the cone with the stabilizer in place. In the alternative, ice cream servings with the stabilizer frozen into place in a non-edible form or support can be made and then transferred into the cone. The latter enhances the ability to rapidly serve many ice cream cones with the stabilizer in place, for example in an amusement park or similar environment.

What is claimed is:

1. A method for reducing risk of spillage from an ice cream cone comprising the steps of:
(a) putting ice cream into an ice cream cone;
(b) inserting a stabilizer through the ice cream, said stabilizer having an generally flat elongated body with first and second ends, the first end being tapered, said tapered end being inserted through the ice cream until it approaches the inside bottom of the cone, while the second end extends upwards above the ice cream, whereby the stabilizer restricts the ability of the ice cream to move sideways relative to the ice cream cone and thus reduce the risk of spillage.

2. The method of claim 1, wherein the stabilizer has
a flared region disposed along the body at a location closer to the second end than the first end, and
a ridge extending along the periphery of body.

3. The method of claim 2, wherein the second end is rounded.

4. The method of claim 1, wherein the second end is rounded.

5. The method of claim 1, wherein the second end comprises a novelty or decorative feature.

6. The method of claim 5, wherein the novelty or decorative feature is made from candy.

7. The method of claim 1, wherein the stabilizer comprises a novelty or decorative feature.

8. The method of claim 9, wherein the novelty or decorative feature is disposed in the flared region.

9. The method of claim 1, wherein the body has a length of from 3 to 9 inches.

10. The method of claim 9, wherein the body has a substantially constant width away from the flared portion, and the length of the body exceed the width by a factor of at least 5.

11. An ice cream stabilizer comprising an generally flat elongated body, said body having
(a) a first end, said first end being tapered
(b) a second end, and
(c) a flared region disposed along the main body at a location closer to the second end than the first end, and
(d) a ridge extending along the periphery of body.

12. The stabilizer of claim 11, wherein the second end is rounded.

13. The stabilizer of claim 10, wherein the second end comprises a novelty or decorative feature.

14. The stabilizer of claim 13, wherein the novelty or decorative feature is made from candy.

15. The stabilizer of claim 11, wherein the stabilizer comprises a novelty or decorative feature.

16. The stabilizer of claim 15, wherein the novelty or decorative feature is disposed in the flared region.

17. The stabilizer of claim 11, wherein the body has a length of from 3 to 9 inches.

18. The stabilizer of claim 17, wherein the body has a substantially constant width away from the flared portion, and the length of the body exceed the width by a factor of at least 5.

19. A combination of an ice cream cone and a stabilizer according to claim 11, wherein the stabilizer is inserted through the ice cream until the tapered first end approaches the inside bottom of the cone, while the second end extends upwards above the ice cream, whereby the stabilizer restricts the ability of the ice cream to move sideways relative to the ice cream cone and thus reduce the risk of spillage.

20. The combination of claim 19, wherein the stabilizer comprises a novelty or decorative feature disposed at the second end or in the flared region.
